(19) United States
(12) Patent Application Publication
(10) Pub. No.: US 2026/0145122 A1
(43) Pub. Date: May 28, 2026

(54) METHOD AND APPARATUS FOR PURGING UNWANTED SUBSTANCES FROM AIR

(71) Applicant: FIPAK Research And Development Company, Rowley, MA (US)

(72) Inventors: Stephane Hauville, Mission Hills, KS (US); Antoine Hauville, La Londe (FR); Cedric Herry, Ploërmel (FR); François Hauville, Ipswich, MA (US)

(21) Appl. No.: 19/402,284

(22) Filed: Nov. 26, 2025

Related U.S. Application Data
(60) Provisional application No. 63/725,929, filed on Nov. 27, 2024.

(51) Int. Cl. B01D 53/32; B01D 53/30; B01D 53/86; B01D 53/88

(52) U.S. Cl. CPC B01D 53/32; B01D 53/30; B01D 53/8675; B01D 53/885; B01D 2255/2073; B01D 2255/20761; B01D 2257/106; B01D 2258/06; B01D 2259/818

(57) ABSTRACT

An air treatment device for removing unwanted substances from air, the air treatment device comprising: a non-thermal plasma reactor stage housing comprising an air inlet for receiving the air to be treated, a plurality of non-thermal plasma reactor units for treating the air and an air outlet for exhausting the treated air from the non-thermal plasma reactor stage housing; wherein each of the plurality of non-thermal plasma reactor units comprises a dielectric substrate having a first surface and a second surface, a first electrode disposed on the first surface of the dielectric substrate and a second electrode disposed on the second surface of the dielectric substrate, wherein the first electrode comprises at least one window exposing the dielectric substrate to the air to be treated in the non-thermal plasma reactor stage housing.

### REFERENCE TO PENDING PRIOR PATENT APPLICATIONS

This patent application claims benefit of pending prior U.S. Provisional Patent Application Ser. No. 63/725,929, filed Nov. 27, 2024 by FIPAK Research and Development Company for METHOD AND APPARATUS FOR PURGING UNWANTED SUBSTANCES FROM AIR (Attorney's Docket No. FIPAK-33 PROV).

The above-identified patent application is hereby incorporated herein by reference

### FIELD OF THE INVENTION

This invention relates to air treatment devices in general, and more particularly to air treatment devices of the sort which purge unwanted substances from air, i.e., to air treatment devices which remove unwanted substances from air and/or neutralize unwanted substances in air and/or convert unwanted substances in air to more acceptable substances.

### BACKGROUND OF THE INVENTION

Air filters are used to purge unwanted substances from air. By way of example but not limitation, air filters are commonly used in laboratories to purge unwanted substances from the air in fumehoods before the air is vented from the fumehood, e.g., to the atmosphere (in the case of a ducted fumehood) or to the ambient air of the laboratory (in the case of a ductless fumehood).

In the laboratory application noted above, the air filter typically uses activated carbon granules to purge unwanted substances from the air. Activated carbon granules are generally preferred for use in air filters because the activated carbon granules are very effective in purging solvents from the air. Furthermore, the use of activated carbon granules is generally highly advantageous, since the activated carbon granules are easily handled, and since they naturally pack into an enclosure with spaces therebetween so as to provide high surface area contact with excellent air flow. Typically, the activated carbon granules are disposed in a simple filter frame, captured between two opposing screens (e.g., meshes, grills, etc.) which pass air therethrough but retain the activated carbon granules therebetween.

While activated carbon granules are extremely effective in purging solvents from the air, they are largely ineffective in purging acids from the air. As a result, where acids may be used within a fumehood, special additives (e.g., rare earth metals, organic metal catalysts, etc.) must be added to the activated carbon granules in order to purge acids from the air. However, these additives tend to reduce the effective surface area of the activated carbon granules, thereby reducing filter capacity. Furthermore, these acid-purging additives are generally only modestly effective in purging acids from the air, and in many cases can include relatively toxic materials which may be released in the air by the air flow through the filter.

Thus it will be seen that incorporating acid-purging additives with the activated carbon granules results in an air filter with reduced efficiency for purging solvents and which has only modest effectiveness for purging acids.

Furthermore, ammonia is one of the most troublesome chemicals present in a laboratory. Among other things, ammonia is highly volatile, has a very low olfactory limit, and is highly detrimental to human health. At the same time, ammonia is also one of the 12 most common chemicals found in a laboratory. For this reason, it is important that there be effective methods and apparatus for protecting laboratory personnel (e.g., chemists, etc.) from the harmful effects of ammonia.

As noted above, because of the harmful properties of ammonia, it is important to protect laboratory personnel from respiratory exposure to ammonia. To this end, filtration fumehoods are commonly used by laboratory personnel to protect themselves from ammonia. In a filtration fumehood (also known as a recirculatory fumehood and/or as a filtering fumehood and/or as a ductless fumehood), impregnated activated carbon granule filters (designed for this specific use) are commonly used to trap ammonia vapors. More particularly, with these activated carbon granule filters, activated carbon granules are impregnated with a chemical specifically chosen for its reaction with ammonia (e.g., sulfuric acid, ZnCl₂, etc.). It is necessary to impregnate the activated carbon granules with an ammonia-purging reactant because “classical” (i.e., non-impregnated) activated carbon granules do not efficiently remove ammonia from air. Hence, it is necessary to impregnate the activated carbon granules with an ammonia-purging reactant so as to attract and neutralize the ammonia vapors.

One aspect of this prior art technology of impregnated activated carbon granule filters is that the combined properties of the activated carbon granules, and the ammonia-purging reactant impregnated in the activated carbon granules, allow the neutralization of a small concentration of ammonia per quantity of impregnated activated carbon granules, with a high efficiency (i.e., greater than 99%, if the filter is correctly designed). However, one of the limits of this prior art technology of impregnated activated carbon granule filters is that the chemical (i.e., the ammonia-purging reactant) used for the impregnation loads the porous network of the activated carbon granules, thereby making it impractical to add other neutralizing and/or purging substances to the impregnated activated carbon granule filter. As a result, where the reactant is selected to neutralize ammonia, the impregnated activated carbon granule filter is effectively limited to neutralizing ammonia (and highly related chemicals).

This same problem tends to occur for impregnated activated carbon granule filters which employ other reactants for purging chemicals other than ammonia from the air (e.g., potassium carbonate for purging inorganic acids, etc.).

Thus it will be seen that with impregnated activated carbon granule filters, each filter is effectively limited to handling a short list of chemicals. As a result, the users of filtration fumehoods must select a particular impregnated activated carbon granule filter for their fumehood in accordance with the chemicals that they will be handling in the fumehood, e.g., an activated carbon granule filter impregnated with sulfuric acid for use when handling ammonia, an activated carbon granule filter impregnated with potassium carbonate for use when handling inorganic acids, etc. This can be problematic, since it may require a filter change when different materials are to be handled in the fumehood.

Furthermore, in some cases, there is no appropriate filter for neutralizing the complete array of chemicals that the user will be handling in the fumehood at a particular time. By way of example but not limitation, a chemist who needs to handle an array of acids, bases and solvents cannot currently easily find a single fumehood filter which can simultaneously protect against all of these chemicals.

Thus there is a need for a new and improved method and apparatus which can effectively handle a broad range of chemicals and biologics which need to be safely handled by laboratory personnel.

### SUMMARY OF THE INVENTION

These and other objects of the present invention are addressed by the provision and use of a new and improved method and apparatus for purging unwanted substances from the air.

In accordance with the present invention, there is now disclosed a novel device for use in purging unwanted substances from air. This novel device may be used alone, or it may be used in combination with one or more of the filters known in the art. Significantly, the novel device hereinafter disclosed is particularly well suited for use in purging unwanted substances from the air of fumehoods before that air is vented, e.g., to the atmosphere (in the case of a ducted fumehood) or to the ambient air of a laboratory containing a fumehood (in the case of a ductless fumehood).

In a preferred form of the invention, there is provided an air treatment device for removing unwanted substances from air, the air treatment device comprising:
a non-thermal plasma reactor stage housing comprising an air inlet for receiving the air to be treated, a plurality of non-thermal plasma reactor units for treating the air and an air outlet for exhausting the treated air from the non-thermal plasma reactor stage housing;
wherein each of the plurality of non-thermal plasma reactor units comprises a dielectric substrate having a first surface and a second surface, a first electrode disposed on the first surface of the dielectric substrate and a second electrode disposed on the second surface of the dielectric substrate, wherein the first electrode comprises at least one window exposing the dielectric substrate to the air to be treated in the non-thermal plasma reactor stage housing.

In another preferred form of the invention, there is provided a method for removing unwanted substances from air, the method comprising:
providing a non-thermal plasma reactor stage housing comprising an air inlet for receiving the air to be treated in the non-thermal plasma reactor stage housing, a plurality of non-thermal plasma reactor units for treating the air and an air outlet for exhausting the treated air from the non-thermal plasma reactor stage housing;
wherein each of the plurality of non-thermal plasma reactor units comprises a dielectric substrate having a first surface and a second surface, a first electrode disposed on the first surface of the dielectric substrate and a second electrode disposed on the second surface of the dielectric substrate, wherein the first electrode comprises at least one window exposing the dielectric substrate to the air to be treated in the non-thermal plasma reactor stage housing; and
passing the air to be treated through the non-thermal plasma reactor stage housing of the air treatment device.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts and further wherein:

FIG. 1 is a schematic view showing a novel apparatus for purging unwanted substances from air, wherein the novel apparatus comprises a novel two-stage air treatment device comprising a non-thermal plasma reactor stage followed by a catalyst stage;

FIGS. 2 and 3 are schematic views of a novel two-stage air treatment device comprising a non-thermal plasma reactor stage followed by a catalyst stage;

FIGS. 4 and 5 are schematic views showing a non-thermal plasma reactor unit of the sort which may be used in the novel two-stage air treatment device of FIGS. 2 and 3;

FIGS. 6 and 7 are schematic views showing two different ways of driving the non-thermal plasma reactor unit of FIGS. 4 and 5;

FIG. 8 is a schematic view showing an alternative form of apparatus for purging unwanted substances from air, wherein the novel apparatus comprises a novel two-stage air treatment device comprising a non-thermal plasma reactor stage followed by a catalyst stage;

FIGS. 9-12 are schematic views showing alternative forms of non-thermal plasma reactor units which may be used with the novel two-stage air treatment device of the present invention;

FIG. 13 is a schematic view showing an alternative form of non-thermal plasma reactor stage;

FIG. 14 is a schematic view showing a novel non-thermal plasma reactor stage formed in accordance with the present invention;

FIGS. 15 and 16 are schematic views showing specific details of an alternative form of a non-thermal plasma reactor unit;

FIG. 17 is a schematic view showing specific details of an alternative form of non-thermal plasma reactor unit;

FIGS. 18-22 are schematic views showing a reactor housing for containing a plurality of reactor units of a non-thermal plasma reactor stage;

FIG. 23 is a schematic view showing a cable for connecting two reactor units of a non-thermal plasma reactor stage;

FIG. 24 is a schematic view showing a novel two-stage air treatment device comprising a non-thermal plasma reactor stage followed by a catalyst stage; and

FIG. 25 is a schematic view showing an alternative form of a novel two-stage air treatment device comprising a non-thermal plasma reactor stage followed by a catalyst stage.

### DETAILED DESCRIPTION OF THE PREFERRED EMBODIMENTS

As discussed above, filters may be used, individually or in combination with one another (e.g., as individual stages in a multi-stage filter), to purge acids from air, or to purge solvents from air, or to purge both acids and solvents from air, including to purge ammonia from air. Such filters are particularly well suited for use in purging unwanted substances from the air of fumehoods before that air is vented, e.g., to the atmosphere (in the case of a ducted fumehood) or to the ambient air of a laboratory containing a fumehood (in the case of a ductless fumehood).

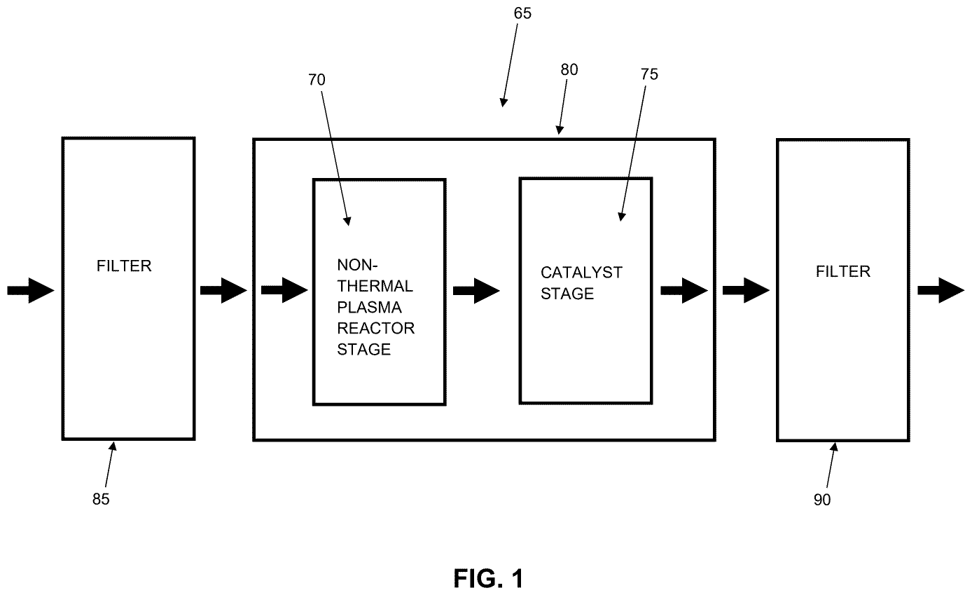

In accordance with the present invention, and looking now at FIGS. 1-3, there is provided a novel two-stage air treatment device 65 for purging unwanted substances from air. Novel two-stage air treatment device 65 comprises a non-thermal plasma reactor stage 70 followed by a catalyst stage 75. In one form of the invention, non-thermal plasma reactor stage 70 and catalyst stage 75 are contained in a single housing 80 (e.g., a housing sized and configured for appropriate mounting in a fumehood, e.g., a ductless fumehood). Thus, in this form of the invention, two-stage air treatment device 65 comprises an assembly comprising non-thermal plasma reactor stage 70 and catalyst stage 75. If desired, another air treatment device 85 (e.g., a filter) may be disposed upstream of air treatment device 65 in order to treat the air before it enters air treatment device 65, and/or another air treatment device 90 (e.g., a filter) may be disposed downstream of air treatment device 65 in order to treat the air after it leaves air treatment device 65. By way of example but not limitation, air treatment device 85 and/or air treatment device 90 may comprise one or both stages of the filters disclosed in U.S. Pat. Nos. 8,152,899, 9,108,141 and 9,114,338, which patents are hereby incorporated herein by reference, e.g., the air filter 5 (e.g., its acid-purging stage 10 and/or its solvent-purging stage 15) and/or the novel filter 60 for purging ammonia and/or other target chemicals from air.

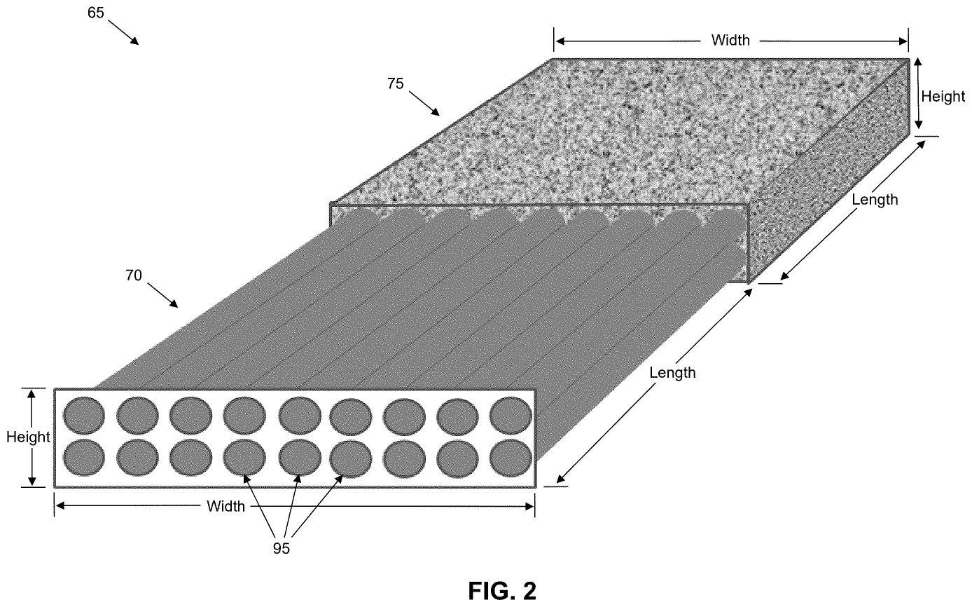

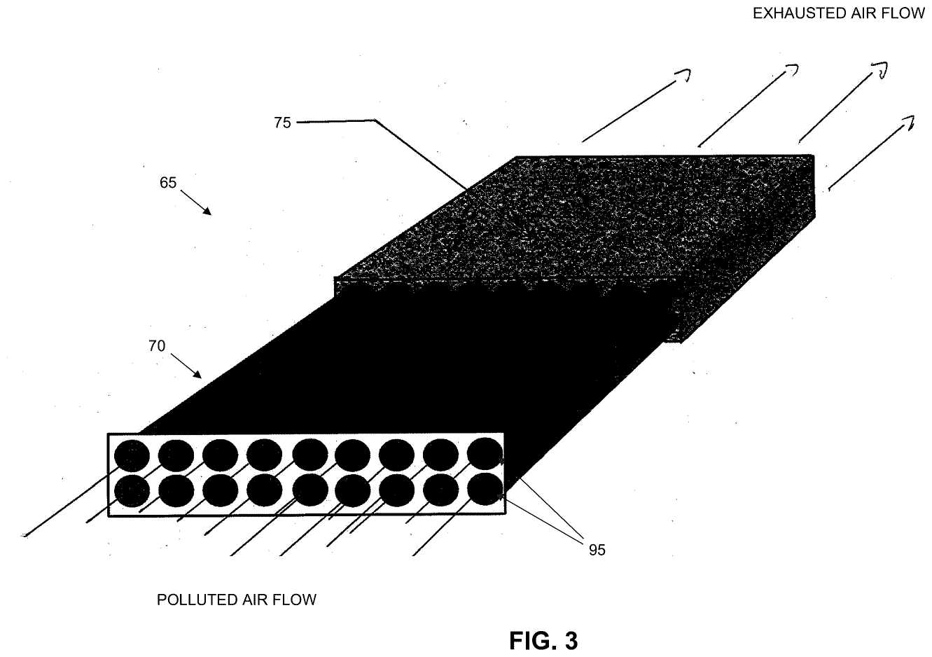

The non-thermal plasma reactor stage 70 includes a plurality of non-thermal plasma reactor units 95 (FIGS. 2 and 3) which are designed to oxidize organic molecules exhausted from a filtration fumehood. Note that FIGS. 2 and 3 are intended to be schematic, in the sense that while they show an exemplary configuration of a given Width×Height×Length, other configurations may also be used, depending on the so-called “form factor” of housing 80 (which may itself depend on the form factor of the fumehood with which the novel two-stage air treatment device 65 is used). Each non-thermal plasma reactor unit 95 is preferably optimized to meet the following requirements:
(i) It should be as small as possible in order to be installed in non-thermal plasma reactor stage 70 of two-stage air treatment device 65, which is itself preferably installed on the top of a fumehood enclosure (not shown). In one preferred form of the invention, the maximum dimension of one non-thermal plasma reactor unit 95 should be smaller than 404 mm (Width)×200 mm (Height)×755 mm (Length).
(ii) Each non-thermal plasma reactor unit 95 should preferably be able to treat an airflow of between about 100 m³/h and about 300 m³/h.
(iii) Each non-thermal plasma reactor unit 95 should preferably be able to treat pollutant concentrations of between about 0 ppm and about 200 ppm, with an efficiency higher than 95%. Note: for purposes of the present invention, the efficiency of non-thermal plasma reactor unit 95 is defined as the ratio between (a) the quantity of pollutant totally converted into non-hazardous sub-products, e.g., CO₂ and H₂O, and (b) the initial quantity of pollutant before introduction into non-thermal plasma reactor unit 95.
(iv) The energy consumption of non-thermal plasma reactor unit 95 should be lower than about 50 J/L of air introduced into non-thermal plasma reactor unit 95.

In order to oxidize the organic pollutants of the air drawn from the fumehood, two-stage air treatment device 65 combines two physical-chemical processes, the first of which is carried out in non-thermal plasma reactor stage 70 and the second of which is carried out in catalyst stage 75:
(i) First, the air from the fumehood passes through a plasma which is created in non-thermal plasma reactor stage 70. More particularly, a plasma is a state of matter similar to gas in which a certain portion of the molecules are ionized. A wide range of different kinds of plasma exist. In the non-thermal plasma reactor units 95 of the present invention, a non-thermal plasma is created, which means that the plasma is created at room temperature. This plasma is created by a discharge generated between two electrodes (see below). When the air from the fumehood passes through the plasma, many by-products are generated, e.g., O·, O₃, OH·, CO, etc. These by-products are relatively unstable and reactive, and are used to oxidize the organic pollutants contained in the air drawn from the fumehood, whereby to treat the organic pollutants contained in the air drawn from the fumehood.
(ii) Second, the air from non-thermal plasma reactor stage 70 is passed through a catalyst bed contained in catalyst stage 75 of two-stage air treatment device 65. This latter stage of two-stage air treatment device 65 is used to achieve oxidation of organic pollutants and to destroy residual ozone (created in the preceding non-thermal plasma reactor stage 70) before releasing the treated air from two-stage air treatment device 65 (e.g., for venting to the atmosphere in the case of a ducted fumehood, or for venting to the ambient air of a laboratory in the case of a ductless fumehood), or for passing the treated air to a downstream filter (e.g., filter 90 shown in FIG. 1) for further treatment of the air before venting to the atmosphere or to the ambient air of a laboratory.

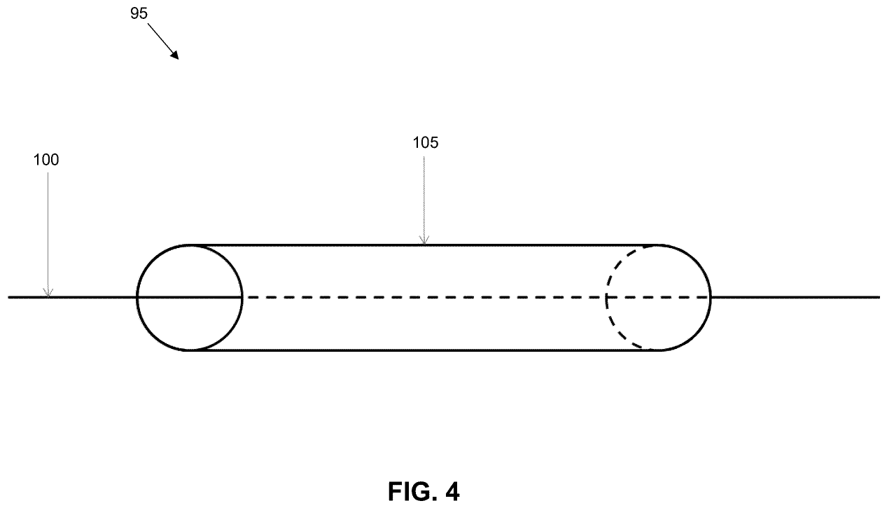

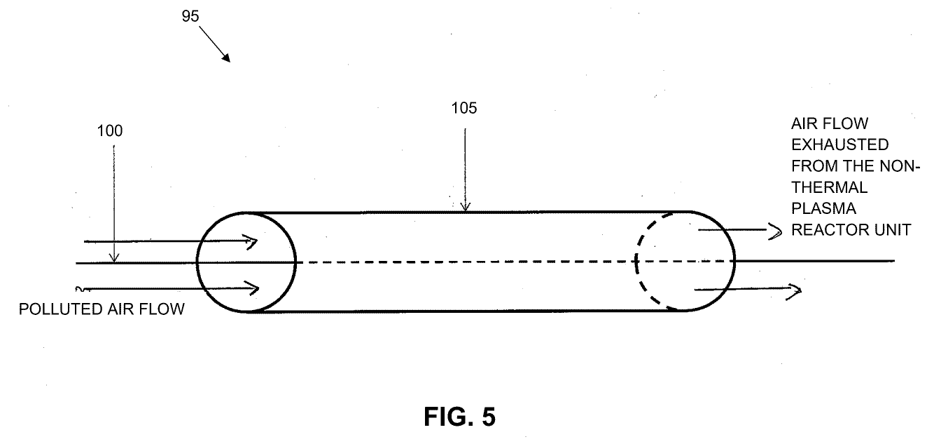

As noted above, non-thermal plasma reactor stage 70 comprises a plurality of non-thermal plasma reactor units 95. In each non-thermal plasma reactor unit 95, a plasma is created between two electrodes. More particularly, and looking now at FIGS. 4 and 5, in one preferred form of the invention, each non-thermal plasma reactor unit 95 of the present invention comprises a so-called “coronal tube” construction, i.e., where non-thermal plasma reactor unit 95 comprises a wire electrode 100 (preferably with a diameter of between about 20 microns and about 60 microns), and a cylinder electrode 105 (preferably with an internal diameter of between about 10 mm and about 30 mm). Various metals may be used to fabricate wire electrode 100 and/or cylinder electrode 105, e.g., copper, iron, stainless steel, tungsten, etc. The length of cylinder electrode 105 is preferably between about 20 cm and about 60 cm. Each non-thermal plasma reactor unit 100 is able to treat an airflow of between 0 and about 100 L/min passing longitudinally through the length of the coronal tube.

In order to treat all of the airflow exhausted from the fumehood, many non-thermal plasma reactor units 95 are assembled together in parallel as shown in FIGS. 2 and 3, whereby to form the complete non-thermal plasma reactor stage 70. This array of parallel coronal tubes preferably has a cross-section (Width×Height) which is equal to the area of the airflow which is to be treated by two-stage air treatment device 65, whereby to ensure maximum treatment of the air.

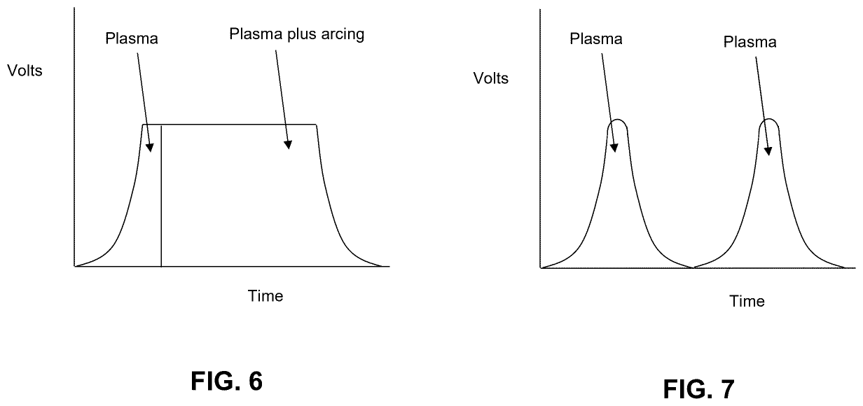

Within the interior of each non-thermal plasma reactor unit 95 (i.e., within the interior of each cylinder electrode 105), a non-thermal plasma is created by applying short electric pulses (preferably approximately 10,000-30,000 V, and preferably approximately 50-2,000 Hz, with the duration of each pulse being about 20 ns at pick middle height). More particularly, when each non-thermal plasma reactor unit 95 comprises a coronal tube construction, it is important to avoid creating an electrical arc within the non-thermal plasma reactor unit 95, since the creation of an electrical arc consumes a large amount of energy and renders the non-thermal plasma reactor stage 70 inefficient. See, for example, FIG. 6, which shows that when the electrical pulses applied to the non-thermal plasma reactor units 95 are not carefully regulated, arcing can occur, with only the leading portion of the electrical pulse being used to create the desired plasma within the non-thermal plasma reactor unit 95 and with the remainder of the electrical pulse creating plasma and arcing. By carefully regulating the electrical pulses applied to non-thermal plasma reactor unit 95, e.g., by keeping the electrical pulses to a short duration such as is shown in FIG. 7, arcing may be effectively eliminated and the non-thermal plasma reactor units 95 driven with significantly higher efficiency.

When the air from the fumehood passes through a non-thermal plasma reactor unit 95, the following reactions (among others) occur:

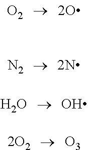

The by-products that are created in non-thermal plasma reactor unit 95 are relatively unstable, which means that they will react with other molecules present in the air from the fumehood in order to create more stable by-products. Most of the reactions result in an oxidation of the organic pollutants contained in the air from the fumehood, whereby to treat the air from the fumehood.

When air is exhausted from a non-thermal plasma reactor unit 95, it can contain residual O₃ (ozone), carbon monoxide (CO), other by-products of the oxidation of the organic pollutants, and residual concentrations of non-oxidized organic pollutants. This mixture is then treated in the second stage of two-stage air treatment device 65, i.e., catalyst stage 75.

Catalyst stage 75 of two-stage air treatment device 65 comprises at least one catalyst and, in a preferred form of the invention, catalyst stage 75 preferably comprises a plurality of different catalysts.

In one preferred form of the invention, catalyst stage 75 comprises MnO₂ (manganese dioxide) as a catalyst. The use of MnO₂ as a catalyst is highly desirable, since MnO₂ promotes the conversion of O₃ into O₂. This conversion reaction of O₃ into O₂ will liberate a large amount of O, which is a relatively unstable molecule which will react with other molecules around it, oxidizing them. In other words, the MnO₂ catalyst promotes the conversion of O₃ so as to liberate a large amount of powerful oxidizers that will react with organic pollutants and organic pollutant by-products in order to convert them into small molecules such as CO, CO₂, and H₂O. The MnO₂ can be supported on various substrates, e.g., ceramic granules, ceramic Raschig rings, open cell foams (e.g., polyurethane, polystyrene, etc.), alumina, activated carbon, charcoal cloths, carbon felt, etc. The MnO₂ catalyst can also be nanostructured, i.e., it can be formed as nano-sized clusters on the surface of a substrate (as opposed to being formed as a continuous uninterrupted coating on the surface of a substrate).

In order to limit the exhaust of CO into a closed space (e.g., the ambient air of a laboratory containing a fumehood), it is preferred to use CuO as a second catalyst in catalyst stage 75. Again, the CuO catalyst can be supported on various substrates as discussed above. This CuO catalyst allows the conversion of CO into CO₂.

Other catalysts may also be provided in catalyst stage 75, e.g., CuO₂, platinum, platinum oxides, gold, etc., and these catalysts may be supported on various substrates as described above.

If desired, the catalysts may be incorporated in a filter element (e.g., activated charcoal granules) so as to simultaneously provide catalyzation and filtration.

Catalyst stage 75 preferably has a “form factor” corresponding to the form factor of non-thermal reactor stage 70 (at least with respect to the cross-section as defined by Width×Height) so as to ensure maximum treatment of the air exiting non-thermal reactor stage 70).

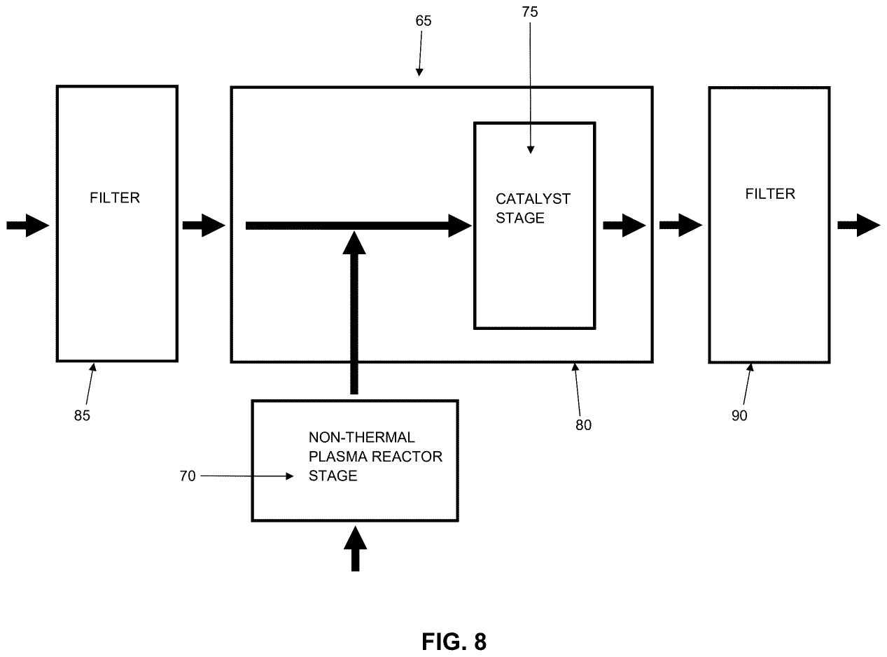

Looking next at FIG. 8, there is shown an alternative form of the present invention. More particularly, in this form of the invention, non-thermal plasma reactor stage 70 is disposed external to housing 80, with the output of non-thermal plasma reactor stage 70 mixing with the air from the fumehood before entering catalyst stage 75. This design can have certain advantages, e.g., it can be safer since the power source powering non-thermal plasma reactor stage 70 is removed from the airflow from the fumehood (which can contain volatile chemicals), and it can be more efficient since the air entering non-thermal plasma reactor stage 70 can be pre-conditioned to optimize plasma creation (e.g., to remove humidity, which can make it more difficult to create a plasma—in practice, this can be a significant advantage, since the air vented from a fumehood is frequently fairly humid).

It will be appreciated that with the construction shown in FIG. 8, the “form factor” of non-thermal reactor stage 70 (i.e., its Width×Height×Length) may vary from the form factor of housing 80 (i.e., its Width×Height×Length) and/or the form factor of catalyst stage 75 (i.e., its Width×Height×Length).

In the foregoing discussion, non-thermal plasma reactor stage 70 is described as comprising a plurality of non-thermal plasma reactor units 95, wherein each non-thermal plasma reactor unit 95 comprises a so-called coronal tube construction comprising one wire electrode 100 and one cylinder electrode 105, with the wire electrode being disposed coaxial with, and internal to, cylinder electrode 105. However, as also noted above, when non-thermal plasma reactor units 95 utilize a coronal tube construction, significant care must be taken to tailor the waveform of the electrical pulses driving the non-thermal plasma reactor units 95 in order to avoid the arcing problem discussed above.

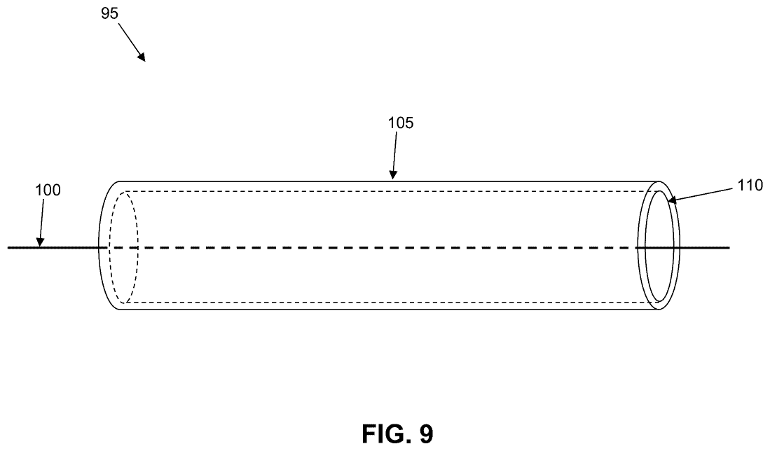

Alternatively, and looking now at FIG. 9, if desired, the non-thermal plasma reactor unit 95 may utilize a so-called dielectric barrier discharge (DBD) construction, where a dielectric tube 110 is disposed coaxial with wire electrode 100 and cylinder electrode 105, with dielectric tube 110 being disposed between wire electrode 100 and cylinder electrode 105. Where the non-thermal plasma reactor unit 95 utilizes a dielectric barrier discharge (DBD) construction, less care must be taken to tailor the waveform of the electrical pulses driving the non-thermal plasma reactor units 95 in order to avoid the arcing problem discussed above.

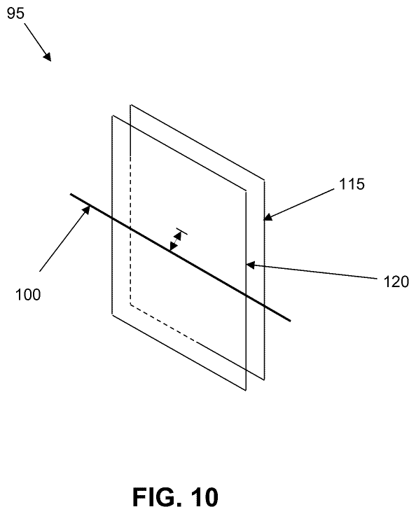

It is also possible for the non-thermal plasma reactor unit 95 to utilize a dielectric barrier discharge (DBD) construction where one of the electrodes comprises a plate. More particularly, and looking now at FIG. 10, there is shown a non-thermal plasma reactor unit 95 comprising a wire electrode 100 and a plate electrode 115, with wire electrode 100 being separated from plate electrode 115 by a dielectric plate 120.

FIG. 10 shows wire electrode 100 being spaced from dielectric plate 120.

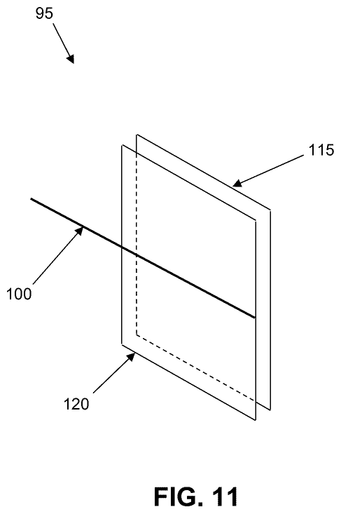

Alternatively, FIG. 11 shows wire electrode 100 being mounted to dielectric plate 120.

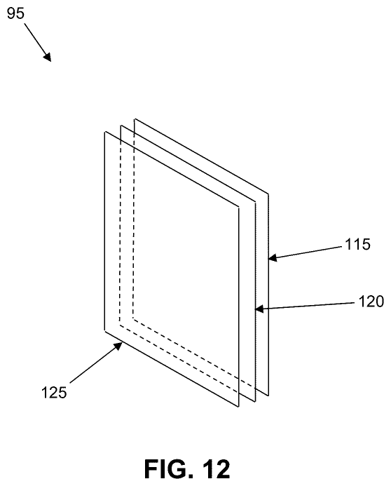

Furthermore, it is possible for the non-thermal plasma reactor unit 95 to utilize a dielectric barrier discharge (DBD) construction where both of the electrodes comprises a plate. More particularly, and looking now at FIG. 12, there is shown a non-thermal plasma reactor unit 95 comprising a first plate electrode 115 and a second plate electrode 125, with first plate electrode 115 being separated from second plate electrode 125 by a dielectric plate 120.

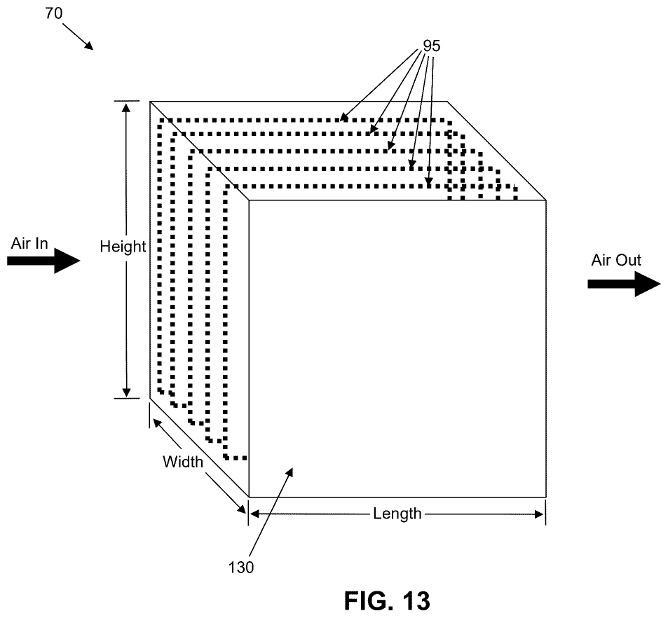

FIG. 13 shows how a plurality of plate-type plasma reactor units 95 may be mounted within a housing 130 so as to constitute a complete non-thermal plasma reactor stage 70. Preferably housing 130 has a cross-section (i.e., Width×Height) corresponding to the area of the airflow which is to be treated by two-stage air treatment device 65, whereby to ensure maximum treatment of the air.

In the preceding sections, there is disclosed a novel two-stage air treatment device 65 which comprises a non-thermal plasma reactor stage 70 followed by a catalyst stage 75. In this respect it should be appreciated that a major function of non-thermal plasma reactor stage 70 is to serve as an ozone generator, which then mixes ozone with the air drawn from the fumehood, whereby to treat the organic pollutants contained in the air drawn from the fumehood, before the molecules are passed through catalyst stage 75. With this in mind, it should be appreciated that it is also possible to substitute other ozone sources for non-thermal plasma reactor stage 70 of novel two-stage air treatment device 65.

Thus, in another form of the present invention, the novel two-stage air treatment device may comprise an ozone source stage followed by a catalyst stage, where the ozone source comprises an ozone generator other than the non-thermal plasma reactor stage 70 described above.

The two-stage air treatment device 65 of the present invention may be used alone to treat the air of a fumehood, or it may be used in conjunction with filters and/or other devices. Thus, for example, in one preferred form of the invention, and looking now at FIGS. 1 and 8, the air from the fumehood may be passed through another air treatment device 85 (e.g., a filter) before it is introduced into two-stage air treatment device 65, and/or the air exiting two-stage air treatment device 65 may be passed through another air treatment device 90 (e.g., a filter) before being vented to the atmosphere (in the case of a ducted fumehood) or to the ambient air of a laboratory (in the case of a ductless fumehood).

In one preferred form of the present invention, air is passed through a filter 85 before it is introduced into air treatment device 65, so as to remove selected substances from the air using filter technology, and then it is passed through air treatment device 65, thereby improving the efficiency of air treatment device 65. By way of example but not limitation, filter 85 may comprise an activated carbon granule filter for removing various solvents (e.g., benzene, isopropyl alcohol, etc.) or other substances from the air before the air is introduced into air treatment device 65. This improves the efficiency of air treatment device 65, because then air treatment device 65 only needs to deal with a smaller number of pollutants. And in one preferred form of the invention, the air exiting air treatment device 65 is passed through another filter 90 before being vented to the atmosphere (in the case of a ducted fumehood) or to the ambient air of a laboratory (in the case of a ductless fumehood). By way of example but not limitation, air treatment device 85 and/or air treatment device 90 may comprise one or both stages of the filters disclosed in U.S. Pat. Nos. 8,152,899, 9,108,141 and 9,114,338, which patents are hereby incorporated herein by reference, e.g., the air filter 5 (e.g., its acid-purging stage 10 and/or its solvent-purging stage 15) and/or the novel filter 60 for purging ammonia and/or other target chemicals from air.

### Alternative Novel Non-Thermal Plasma Reactor Stage

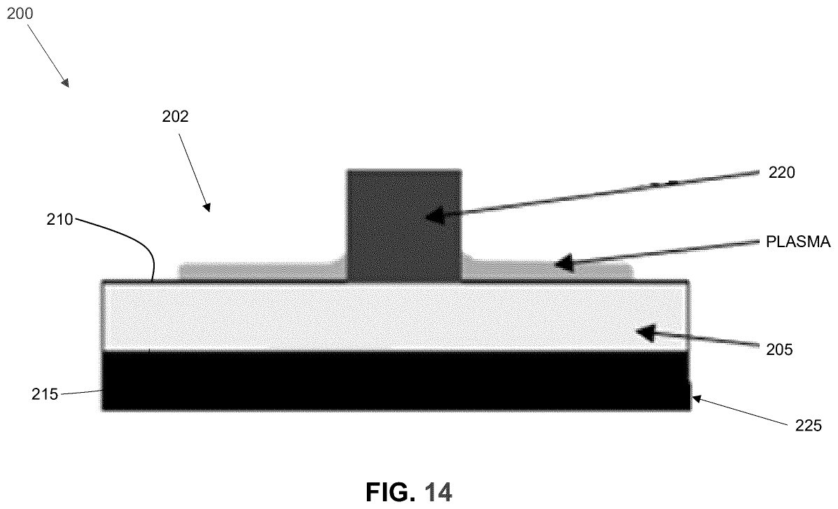

Looking now at FIG. 14, there is shown a novel non-thermal plasma reactor stage 200 for use in any air treatment device (e.g., a fumehood, an air purifier, etc.) or in any enclosed space in which it is desirable to generate plasma for removing unwanted substances from air and/or neutralizing unwanted substances in air and/or converting unwanted substances in air to more acceptable substances (e.g., a room, a biological safety cabinet (BSC), a chemical storage cabinet, etc.).

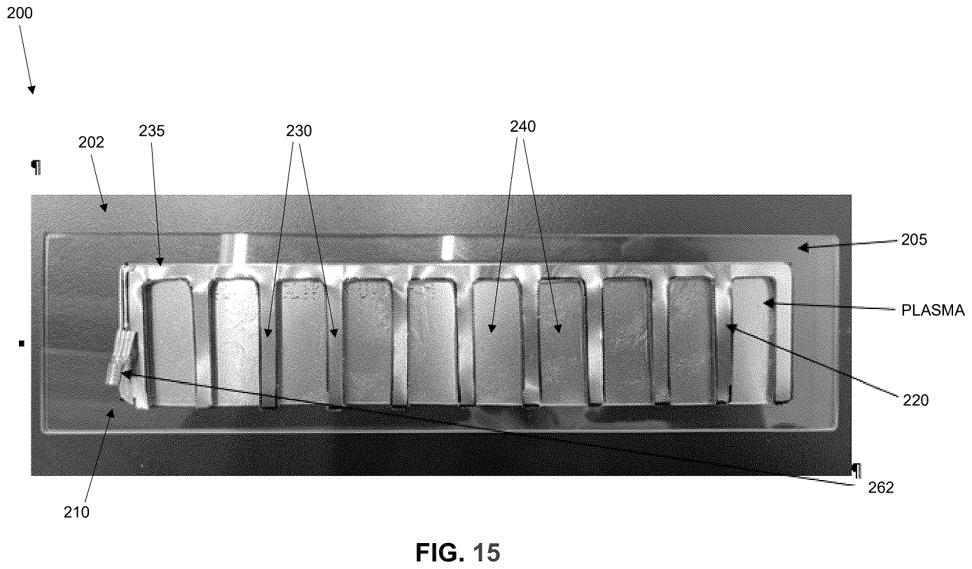

Looking now at FIGS. 15-17, non-thermal plasma reactor stage 200 comprises at least one novel reactor unit 202 formed in accordance with the present invention.

More particularly, reactor unit 202 generally comprises a dielectric substrate 205 comprising a front surface 210 and a rear surface 215. A first electrode 220 is mounted to front surface 210 of substrate 205 and a second electrode 225 is mounted to rear surface 215 of substrate 205.

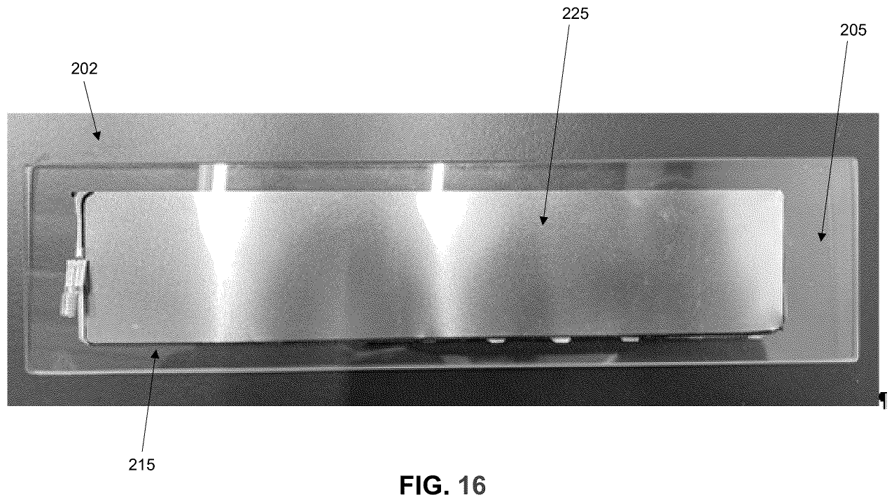

In a preferred form of the invention, and looking now at FIGS. 15 and 16, first electrode 220 may be formed in the shape of a “comb”. With this form of the invention, first electrode 220 comprises a plurality of arm segments 230 connected together by single spine 235. Arm segments 230 are preferably disposed in parallel relation so as to extend from spine 235 with a pre-determined gap existing between adjacent arm segments 230, whereby to define a plurality of windows 240.

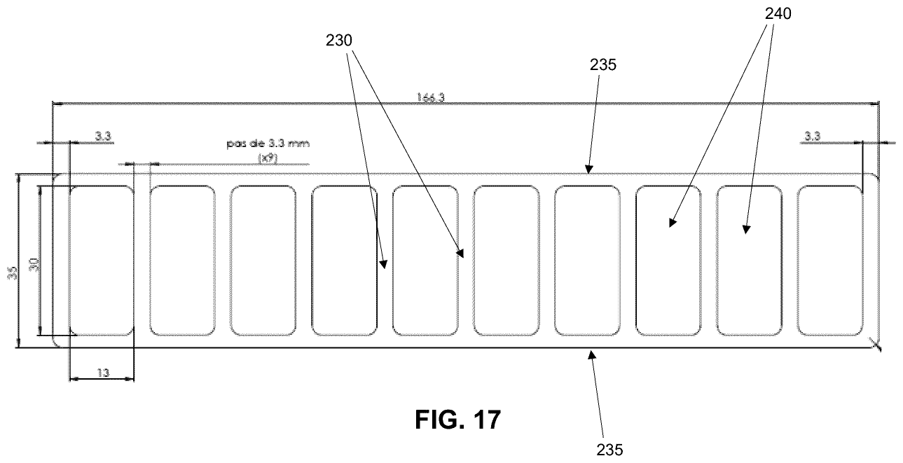

Alternatively, if desired, and looking now at FIG. 17, first electrode 220 may be formed in the shape of a “ladder”. With this form of the invention, the plurality of arm segments 230 of first electrode 220 are connected together by two spines 235 disposed at opposite ends of first electrode 220 (arrayed perpendicular to the plurality of arm segments 230).

It should be appreciated that, while first electrode 220 is depicted in FIGS. 15 and 17 as comprising either a “comb” configuration (FIG. 15), or a “ladder” configuration (FIG. 17), first electrode 220 may comprise substantially any configuration in which an electrode is mounted to front surface 210 of dielectric substrate 205 in such a way that at least one opening exposes front surface 210 of dielectric substrate 205 to air that enters non-thermal plasma reactor stage 200. By way of example but not limitation, if desired, first electrode 220 may comprise a plate having a plurality of small holes formed therein with regular or irregular disposition across the plate electrode in communication with front surface 210 of dielectric substrate 205. Small holes may comprise identical or non-identical openings of substantially any geometry and size.

Plasma is created within each of the windows 240 (i.e., at the exposed front surface 210 of dielectric substrate 205) of reactor unit 202 by applying short electric pulses (e.g., approximately 10,000-30,000 V, for approximately 50-2,000 Hz, with the duration of each pulse being about 20 ns) to electrodes 220, 225.

As discussed above in the context of the aforementioned non-thermal plasma reactor units 95, by keeping the electrical pulses to a short duration, electrical arcing may be eliminated and the plasma reactor may operate with higher efficiency. When air (e.g., ambient air, air removed from the workspace of a fumehood, etc.) is passed adjacent to windows 240 so as to interact with plasma generated at the exposed front surface 210 of dielectric substrate 205, the following reactions (among others) occurs:

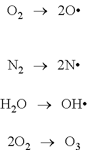

The by-products (e.g., 2 O·, 2 N·, OH·, O₃, CO, etc.) yielded by this reaction are relatively unstable, meaning that these by-products will react with other molecules present in the air in order to create more stable by-products, as will hereinafter be discussed in further detail.

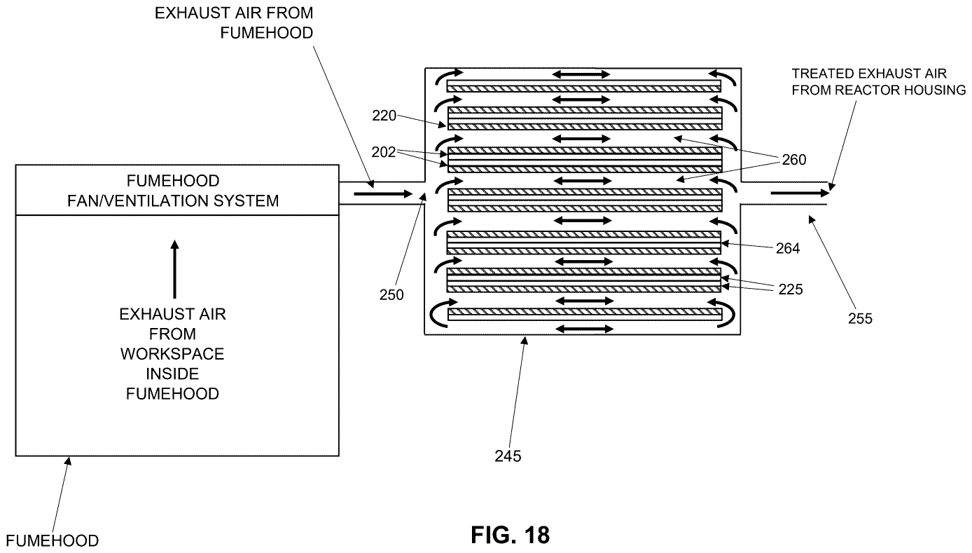

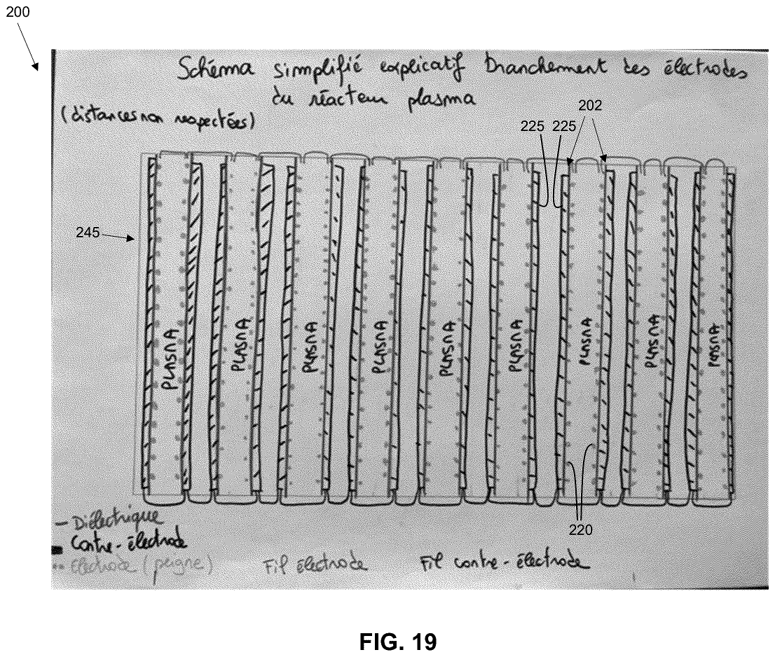

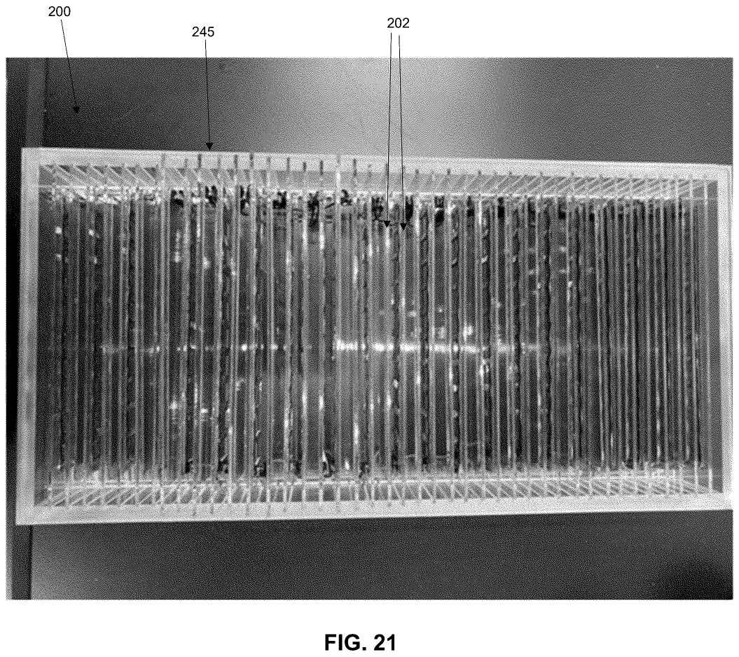

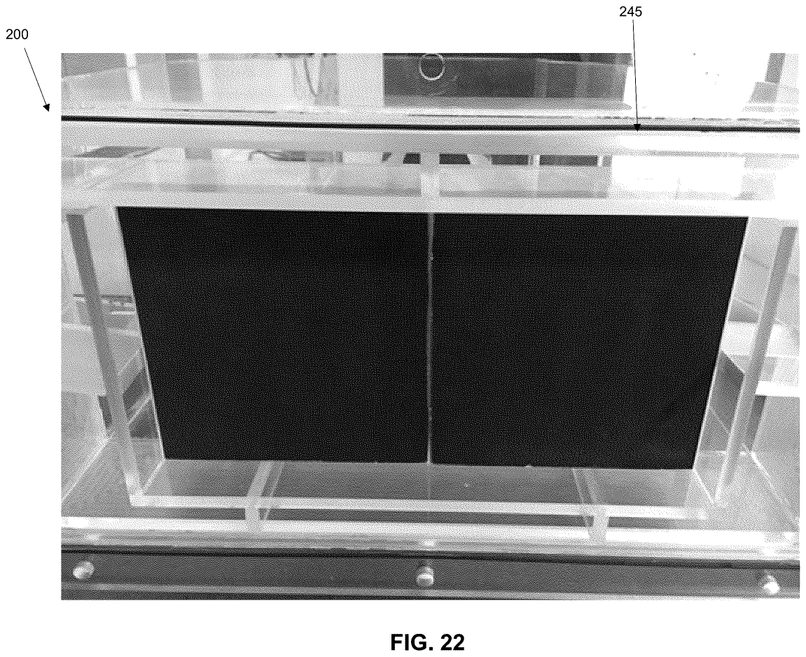

Looking now at FIGS. 18-22, non-thermal plasma reactor stage 200 preferably comprises a reactor housing 245 which surrounds a plurality of reactor units 202 so as to contain a plurality of reactor units within a fluidically-sealed enclosure. Reactor housing 245 generally comprises an inlet 250 for introducing air into reactor housing 245, and an outlet 255 for removing air from reactor housing 245, as will hereinafter be discussed. It will be appreciated that, although inlet 250 and outlet 255 are shown in FIG. 18 schematically as disposed at opposite ends of reactor housing 245, inlet 250 and outlet 255 may be disposed substantially anywhere in the side wall (or top cover, bottom cover, etc.) of reactor housing 245 in order to maximize air flow through the reactor housing, as will be apparent to one of ordinary skill in the art in view of the present disclosure.

In one preferred form of the invention, and still looking at FIGS. 18-22, a plurality of reactor units 202 are arranged within reactor housing 245 in parallel disposition with one another. With this form of the invention, adjacent reactor units 202 are preferably disposed relative to reactor housing 245 such that the first electrodes 220 of two adjacent reactor units 202 face one another, with a gap 260 extending between the two adjacent first electrodes 220. In a preferred form of the invention, the two adjacent first electrodes 220 of two adjacent reactor units 202 are separated by a gap 260 measuring approximately 5-20 mm across. As a result of this construction, when an electric current is passed through reactor units 202, plasma is generated in each of the plurality of windows 240 defined by first electrode 220. At the same time plasma is being generated in each of the plurality of windows 240 defined by first electrode 220, plasma is not being generated between two adjacent second electrodes 225. Therefore, a wall 264 is preferably provided to prevent contaminated air from passing by the area between two adjacent second electrodes 225.

Since adjacent reactor units are arrayed in parallel disposition with one another such that their respective first electrodes 220 face one another, the plasma generated in the gap between adjacent first electrodes is concentrated, with the result that the by-products (e.g., 2 O·, 2 N·, OH·, O₃, CO, etc.) yielded by the reaction of the plasma with air passed through reactor 245 are maximized. As a result of this construction, the reactions between the by-products and molecules contained within the air passed through reactor housing 245 are also maximized, whereby to maximize the treatment of the air passed through reactor housing 245 by those by-products, as will hereinafter be discussed in further detail.

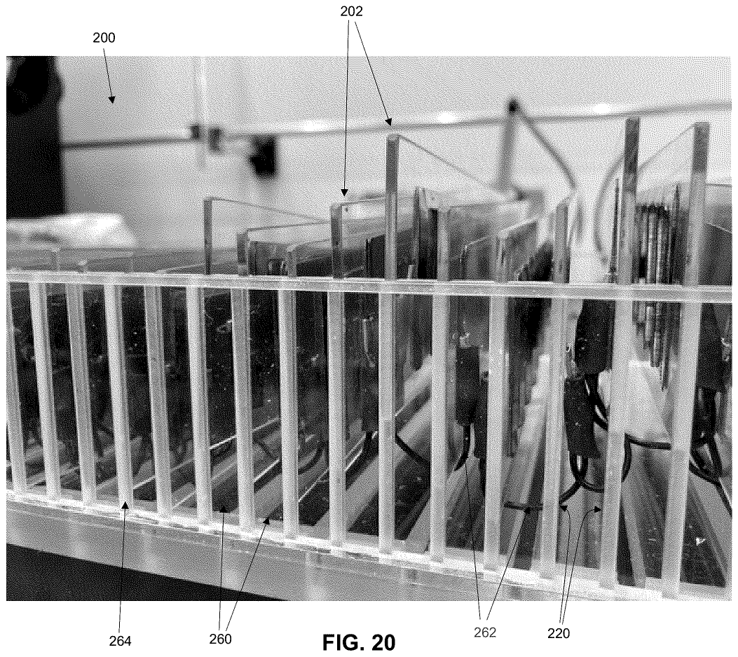

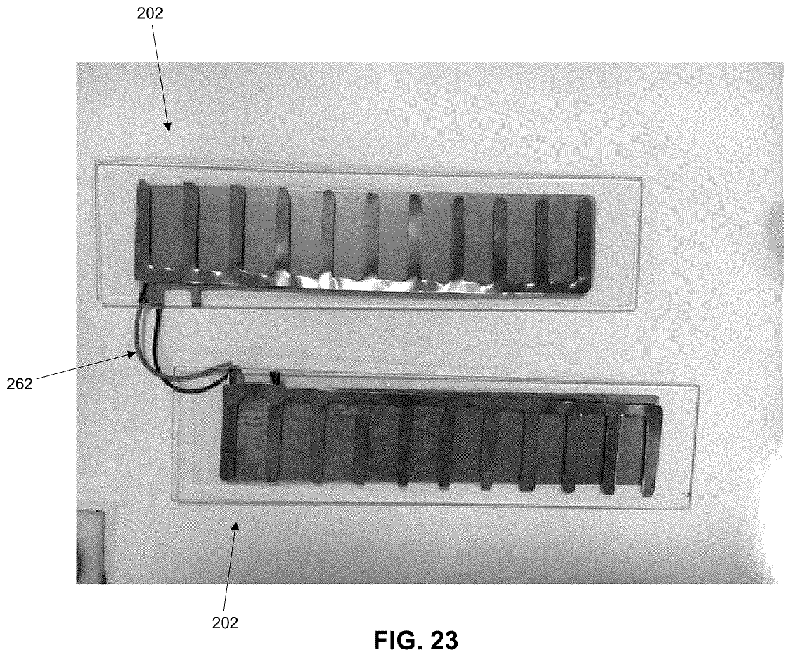

Additionally, if desired, and looking now at FIG. 23, it should be appreciated that adjacent reactor units 202 may be electrically connected together via cabling 262, whereby to permit a single source of power to simultaneously energize both of the adjacently-disposed reactor units 202 simultaneously. Alternatively and/or additionally, and looking now at FIG. 20, if desired, a plurality of reactor units 202 may be electronically connected together via cabling 262, whereby to permit the plurality of reactor units 202 to be simultaneously energized and/or pulsed, as desired.

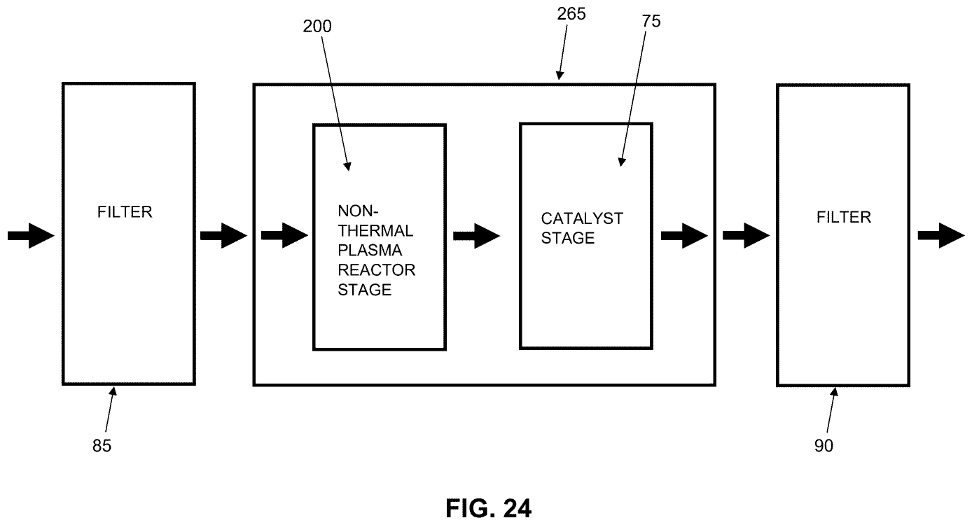

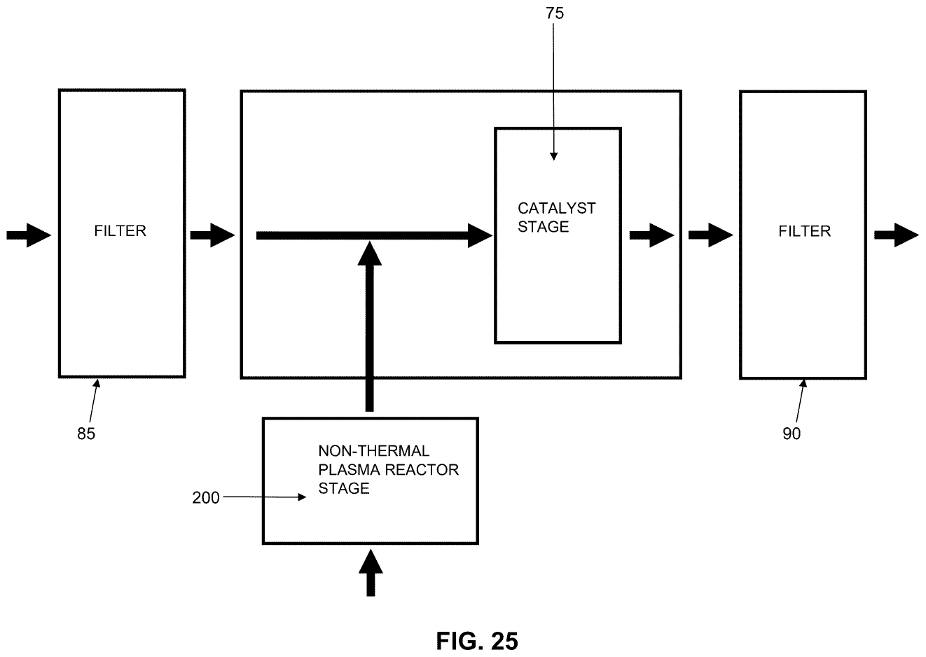

In one form of the present invention, novel non-thermal plasma reactor stage 200 may be used in two-stage air treatment device 65 discussed above (e.g., in place of non-thermal plasma reactor stage 70 discussed above), as shown in FIGS. 24 and 25.

More particularly, and looking now at FIG. 24, if desired, non-thermal plasma reactor stage 200 and the aforementioned catalyst stage 75 are contained in a single housing 265 (e.g., a housing sized and configured for appropriate mounting in a fumehood, e.g., a ducted or ductless fumehood), or a BSC. Thus, in this form of the invention, two-stage air treatment device 265 comprises an assembly comprising non-thermal plasma reactor stage 200 and catalyst stage 75. If desired, another air treatment device 85 (e.g., a filter) may be disposed upstream of air treatment device 265 in order to treat the air before it enters air treatment device 265, and/or another air treatment device 90 (e.g., a filter) may be disposed downstream of air treatment device 265 in order to treat the air after it leaves air treatment device 265. By way of example but not limitation, air treatment device 85 and/or air treatment device 90 may comprise one or both stages of the filters disclosed in U.S. Pat. Nos. 8,152,899, 9,108,141 and 9,114,338, which patents are hereby incorporated herein by reference, e.g., the air filter 5 (e.g., its acid-purging stage 10 and/or its solvent-purging stage 15) and/or the novel filter 60 for purging ammonia and/or other target chemicals from air.

As discussed above with respect to two-stage air treatment device 65, in order to purge unwanted substances from the air of a fumehood (or a BSC) before that air is vented, e.g., to the atmosphere (in the case of a ducted fumehood) or to the ambient air of a laboratory containing a fumehood (in the case of a ductless fumehood), two-stage air treatment device 265 combines two physical-chemical processes, the first of which is carried out in non-thermal plasma reactor stage 200 (e.g., for generating byproducts such as ozone and carbon monoxide from the organic pollutants of the air drawn from the fumehood), and the second of which is carried out in catalyst stage 75 (e.g., for converting the byproducts such as ozone and carbon monoxide to oxygen and carbon dioxide). In a preferred form of the present invention, purging unwanted substances from the air of fumehoods before that air is vented includes the following steps:
(i) First, the air from the fumehood (or BSC) passes through a plasma which is created by the reactor units 202 of non-thermal plasma reactor stage 200 contained within reactor housing 245 so that air from the fumehood (or BSC) interacts with the plasma created by the reactor units 202. More particularly, a plasma is a state of matter similar to a gas in which a certain portion of the molecules are ionized. A wide range of different kinds of plasma exist. In the non-thermal plasma reactor stage 200 of the present invention, a non-thermal plasma is created by each of the reactor units 202 (see above), which means that the plasma is created at room temperature. This plasma is created by a discharge generated between two electrodes. When the air from the fumehood (or BSC) passes through the plasma, many byproducts are generated, e.g., 2 O·, 2 N·, OH·, O₃, CO, etc.). These byproducts are relatively unstable and reactive, and are used to oxidize the organic pollutants contained in the air drawn from the fumehood (or BSC), whereby to treat the organic pollutants contained in the air drawn from the fumehood.
(ii) Second, the air from the non-thermal plasma reactor stage 200 (i.e., air exiting through outlet 255 of reactor housing 245) is passed through a catalyst bed contained in catalyst stage 75 of two-stage air treatment device 265. This latter stage of two-stage air treatment device 265 is used to achieve oxidation of organic pollutants and to destroy residual ozone (created by non-thermal plasma reactor stage 200) before releasing the treated air from two-stage air treatment device 265 (e.g., for venting to the atmosphere in the case of a ducted fumehood, or for venting to the ambient air of the laboratory in the case of a ductless fumehood), or for passing the treated air to a downstream filter (e.g., the aforementioned second air treatment device 90) for further treatment of the air before venting to the atmosphere or to the ambient air of a laboratory.

Looking now at FIG. 25, there is shown another form of the present invention. More particularly, in this form of the invention, non-thermal plasma reactor stage 200 (i.e., reactor housing 245 comprising a plurality of reactor units 202) is disposed external to a housing 265 comprising the aforementioned catalyst stage 75. With this form of the invention, the output of non-thermal plasma reactor stage 200 is mixed with the air from the fumehood (or BSC) before entering catalyst stage 75. This design can have certain advantages over the two-stage air treatment device configuration depicted in FIG. 24, e.g., the form of the invention depicted in FIG. 25 can be safer since the power source powering non-thermal plasma reactor stage 200 is removed from the airflow from the fumehood (or BSC) (which airflow can contain volatile chemicals), and it can be more efficient since the air entering non-thermal plasma reactor stage 200 can be pre-conditioned to optimize plasma creation (e.g., to remove humidity, which can make it more difficult to create a plasma—in practice, this can be a significant advantage, since the air vented from a fumehood (or a BSC) is frequently fairly humid).

It will be appreciated that with the constructions shown in FIGS. 24 and 25, the boxes representing the various elements of the invention are schematic only and not intended to convey relative sizes/form factors of the elements depicted. Specifically, the “form factor” of non-thermal plasma reactor stage 200 (i.e., its Width×Height×Length) may vary from the form factor of the housing containing catalyst stage 75 (i.e., its Width×Height×Length) and/or the form factor of catalyst stage 75 itself (i.e., its Width×Height×Length).

It will be appreciated that, if desired, one or both of first air treatment device 85 and second air treatment device 90 may be omitted from the configurations of either or both of FIGS. 24 and 25.

In addition to using air non-thermal plasma reactor stage 70 and/or novel non-thermal plasma reactor stage 200 with catalyst stage 75 in a fumehood or a biological safety cabinet (BSC), air non-thermal plasma reactor stage 70 and/or novel non-thermal plasma reactor stage 200 could also be used to purify the air that is recirculating internally within a chemical storage cabinet (or other confined space) or in an air purification device disposed in any room. In this application, the non-thermal plasma reactor stage 70, and/or novel non-thermal plasma reactor stage 200, and catalyst stage 75 act as a filter for removing unwanted substances from air and/or neutralizing unwanted substances in air and/or converting unwanted substances in air to more acceptable substances. By way of example, non-thermal plasma reactor stage 70 and/or novel non-thermal plasma reactor stage 200 may be used in addition to, or in place of, the filter in the air purification device sold by Erlab D.F.S. S.A.S under the HALO® trademark.

If desired, two-stage air treatment device 65 (or two-stage air treatment device 265) may comprise a sensor and appropriate computer control to activate non-thermal plasma reactor stage 70 (and/or novel non-thermal plasma reactor stage 200) when necessary (e.g., at a certain time of day or when the sensor detects a substance that the non-thermal plasma reactor stage may be configured to remove from the air). Such a sensor-based system reduces power consumption by only generating ozone, etc., when appropriate pollutants are detected. By limiting the activation of non-thermal plasma reactor stage 70 (and/or novel non-thermal plasma reactor stage 200) to certain times of day (or the presence of certain pollutants), the energy consumption associated with plasma generation can be reduced, and the amount of ozone being generated can be precisely controlled depending on what is needed for air purification. Appropriate sensors for the foregoing application will be apparent to a person of skill in the art in view of the present disclosure.

In another form of the present invention, non-thermal plasma reactor stage 70 and/or novel non-thermal plasma reactor stage 200 may be used without catalyst stage 75.

As discussed above, non-thermal plasma reactor stage 70 and/or non-thermal plasma reactor stage 200 generate ozone (O₃) which may be used to oxidize organic pollutants drawn from a fumehood, a BSC or any other confined space. However, it should also be appreciated that, if desired, ozone generated by plasma reactor stage 70 (and/or non-thermal plasma reactor stage 200) may be passed into the fumehood or a BSC in order to decontaminate the inner space/surfaces of the fumehood or the BSC. Specifically, prior art “decontamination protocols” for fumehoods (and other enclosed spaces) have relied on utilizing formaldehyde and/or hydrogen peroxide. However, formaldehyde is a carcinogen, and therefore not ideal as a decontaminant. Hydrogen peroxide is frequently a controlled substance (due to its being a chemical precursor to certain explosives) and therefore often challenging to acquire in adequate quantities for effecting decontamination. Thus, the ozone generated by non-thermal plasma reactor stage 70 and/or non-thermal plasma reactor stage 200 can serve as a decontaminant when introduced into a confined space (e.g., a fumehood or a BSC) while completely eliminating the problems with decontaminants used in prior art purification devices.

It should also be appreciated that such oxidizing ozone generated by non-thermal reactor stage 70 and/or non-thermal plasma reactor stage 200 can be introduced into any confined space (e.g., a fumehood, a BSC, a laboratory, a chemical storage cabinet) so as to decontaminate the confined space (without catalyst stage 75). It should also be appreciated that non-thermal reactor stage 70 and/or non-thermal plasma reactor stage 200 may operate continuously to decontaminate the confined space, or a sensor and the appropriate computer control can be provided for activating the non-thermal reactor stage 70 and/or non-thermal plasma reactor stage 200 only when necessary.

### MODIFICATIONS OF THE INVENTION

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. An air treatment device for removing unwanted substances from air, the air treatment device comprising:
a non-thermal plasma reactor stage housing comprising an air inlet for receiving the air to be treated, a plurality of non-thermal plasma reactor units for treating the air and an air outlet for exhausting the treated air from the non-thermal plasma reactor stage housing;
wherein each of the plurality of non-thermal plasma reactor units comprises a dielectric substrate having a first surface and a second surface, a first electrode disposed on the first surface of the dielectric substrate and a second electrode disposed on the second surface of the dielectric substrate, wherein the first electrode comprises at least one window exposing the dielectric substrate to the air to be treated in the non-thermal plasma reactor stage housing.

2. The air treatment device of claim 1 wherein the plurality of non-thermal plasma reactor units are arranged in parallel within the non-thermal plasma reactor stage housing.

3. The air treatment device of claim 2 wherein the first electrode of one of the plurality of non-thermal plasma reactor units faces the first electrode of a second one of the plurality of non-thermal plasma reactor units.

4. The air treatment device of claim 2 wherein the first electrode of one of the plurality of non-thermal plasma reactor units is separated by the first electrode of another one of the plurality of non-thermal plasma reactor units by a gap measuring approximately 5-20 mm across.

5. The air treatment device of claim 1 wherein a wall separates the second electrode of one of the plurality of non-thermal plasma reactor units from the second electrode of another one of the plurality of non-thermal plasma reactor units.

6. The air treatment device of claim 1 wherein the at least one window of the first electrode is disposed between a plurality of arm segments.

7. The air treatment device of claim 6 wherein the plurality of arm segments are disposed in a parallel arrangement and connected together by a spine extending perpendicular to the plurality of arm segments.

8. The air treatment device of claim 6 wherein the plurality of arm segments are disposed in a parallel arrangement and connected together by two spines extending perpendicular to the plurality of arm segments.

9. The air treatment device of claim 1 wherein the at least one window of the first electrode comprises at least one hole formed in the first electrode.

10. The air treatment device of claim 9 wherein the first electrode comprises a plate comprising a plurality of holes arranged in a regular disposition across the plate of the first electrode.

11. The air treatment device of claim 9 wherein the first electrode comprises a plate comprising a plurality of holes arranged in an irregular disposition across the plate of the first electrode.

12. The air treatment device of claim 1 wherein at least one of the plurality of non-thermal plasma reactor units is electrically connected to another one of the plurality of non-thermal plasma reactor units via a cable.

13. The air treatment device of claim 1 further comprising a catalyst stage downstream of the plurality of non-thermal plasma reactor units for further treating the air exiting the non-thermal plasma reactor stage housing.

14. The air treatment device of claim 13 wherein the catalyst stage comprises at least one from the group consisting of MnO₂ and CuO.

15. The air treatment device of claim 1 further comprising a filter.

16. The air treatment device of claim 1 wherein the plurality of non-thermal plasma reactor units are driven by electrical pulses, and further wherein the electrical pulses are regulated to minimize arcing.

17. The air treatment device of claim 16 wherein each electric pulse is approximately 10,000 V-30,000 V, at a frequency of approximately 50-2,000 Hz for a duration of approximately 20 ns.

18. The air treatment device of claim 1 further comprising a sensor for detecting the presence of a substance in the air and activating the plurality of non-thermal plasma reactor units to treat the air.

19. A method for removing unwanted substances from air, the method comprising:
providing a non-thermal plasma reactor stage housing comprising an air inlet for receiving the air to be treated in the non-thermal plasma reactor stage housing, a plurality of non-thermal plasma reactor units for treating the air and an air outlet for exhausting the treated air from the non-thermal plasma reactor stage housing;
wherein each of the plurality of non-thermal plasma reactor units comprises a dielectric substrate having a first surface and a second surface, a first electrode disposed on the first surface of the dielectric substrate and a second electrode disposed on the second surface of the dielectric substrate, wherein the first electrode comprises at least one window exposing the dielectric substrate to the air to be treated in the non-thermal plasma reactor stage housing; and
passing the air to be treated through the non-thermal plasma reactor stage housing of the air treatment device.

20. The method of claim 19 wherein the plurality of non-thermal plasma reactor units are arranged in parallel within the non-thermal plasma reactor stage housing.

21. The method of claim 19 wherein the plurality of non-thermal plasma reactor units are driven by electrical pulses, and further wherein the electrical pulses are regulated to minimize arcing.

22. The method of claim 21 wherein each electric pulse is approximately 10,000 V-30,000 V, at a frequency of approximately 50-2,000 Hz for a duration of approximately 20 ns.

23. The method of claim 19 wherein exposing the air to the dielectric substrate generates ozone.

24. The method of claim 23 further comprising passing the ozone through a catalyst stage, wherein the catalyst stage is formed separately from the non-thermal plasma reactor stage housing.

25. The method of claim 23 further comprising passing the generated ozone into a confined space to decontaminate the confined space.
